(19) United States
(12) Patent Application Publication
(10) Pub. No.: US 2020/0001629 A1
(43) Pub. Date: Jan. 2, 2020

(54) RECORDING DEVICE

(71) Applicant: SEIKO EPSON CORPORATION, Tokyo (JP)

(72) Inventor: Yoji TAKAHASHI, Matsumoto-shi (JP)

(73) Assignee: SEIKO EPSON CORPORATION, Tokyo (JP)

(21) Appl. No.: 16/457,007

(22) Filed: Jun. 28, 2019

(30) Foreign Application Priority Data
Jun. 29, 2018 (JP) 2018-124072

(51) Int. Cl. B41J 11/58; B65H 19/12; G03B 21/43; B65H 75/18

(52) U.S. Cl. CPC B41J 11/58; B65H 19/126; G03B 21/43; B65H 2801/03; B65H 2402/32; B65H 2402/50; B65H 75/18

(57) ABSTRACT

A winding unit includes a rail extending in an X direction, a support portion that is supported on the rail, that is movable in the X direction, and that is capable of supporting rolled medium, and a support mechanism that is supported on the rail and that is movable in the X direction. The support mechanism includes a placement portion capable of supporting the rolled medium from a vertically downward direction side, and a position adjustment unit that rises the placement portion in a vertically upward direction when the rolled medium is removed from the support portion. When viewed from a Y direction intersecting the X direction, a placement surface of the placement portion on which the rolled medium is placed is curved to be convex in the vertically upward direction.

The present application is based on, and claims priority from JP Application Serial Number 2018-124072, filed Jun. 29, 2018, the disclosure of which is hereby incorporated by reference herein in its entirety.

### BACKGROUND

### 1. Technical Field

The present disclosure relates to a recording device.

### 2. Related Art

A so-called roll-to-roll type large printing apparatus (recording device) is known in which a medium (media) is supplied from a rolled medium wound in a roll shape, and the medium after recording has been completed is wound and collected in a roll shape.

For example, a recording device described in JP-A-2017-109334 includes a feeding unit that unwinds and feeds a medium from a rolled medium, a recording unit that records a desired image on the medium, and a winding unit. The winding unit includes a pair of holders and a motor that drives either one of the pair of holders, winds the medium after recording has been completed in a roll shape, and holds the medium as a rolled medium. Furthermore, when winding of the medium is completed in the winding unit, an operator removes and collects the rolled medium from the winding unit.

In the recording device described in JP-A-2017-109334, when a weight of the rolled medium increases due to an increase in the amount of medium wound into the rolled medium or in the width of the medium, a burden on an operator when removing the rolled medium from the winding unit increases, and it becomes difficult for the operator to efficiently remove the rolled medium from the winding unit. Furthermore, when a weight of the rolled medium increases, excessive force is more likely to act on the rolled medium when the rolled medium is removed from the winding unit, and there is also a risk that defects (folds, scratches, and the like) that are difficult to repair may be generated in the rolled medium due to the excessive force.

### SUMMARY

A recording device of the present application includes a winding unit configured to wind a medium into a roll shape to form a rolled medium, wherein the winding unit includes a rail extending in a first direction, and a support mechanism supported on the rail and configured to move in the first direction, the support mechanism includes a placement portion configured to support the rolled medium from a vertically downward direction, and a position adjustment unit configured to rise the placement portion in a vertically upward direction, and when viewed from a second direction intersecting the first direction, a placement surface of the placement portion on which the rolled medium is placed is curved to be convex in the vertically upward direction.

In the recording device of the present application, the support mechanism preferably further includes a second placement portion aligned with the placement portion in the first direction and configured to support the rolled medium from the vertically downward direction, and when viewed from the second direction, a placement surface of the second placement portion on which the rolled medium is placed is preferably curved to be convex in the vertically upward direction.

In the recording device of the present application, the position adjustment unit preferably includes a shaft extending in the second direction, a lever fixed to the shaft and configured to rotate with the shaft serving as a fulcrum, at least one cam fixed to the shaft, the at least one cam being configured to rotate to convert rotational movement of the lever into oscillatory movement in the vertically upward direction or the vertically downward direction, a rising and lowering portion configured to rise in the vertically upward direction or configured to lower in the vertically downward direction by the at least one cam and that supports the placement portion, and a base housing the rising and lowering portion, and the lever preferably intersects the second direction.

In the recording device of the present application further comprises a second support mechanism and a second lever disposed in the second support mechanism, and a position of the lever in the second direction is preferably different from a position of the second lever in the second direction, such that the lever and the second lever preferably do not interfere with each other when the lever and the second lever are rotated with the shaft serving as a fulcrum.

In the recording device of the present application, the rising and lowering portion preferably includes a first rising and lowering portion disposed inside the base and a second rising and lowering portion disposed inside the first rising and lowering portion and that supports the placement portion.

In the recording device of the present application, at least one rolling body is preferably disposed between the base and the first rising and lowering portion and between the first rising and lowering portion and the second rising and lowering portion.

In the recording device of the present application, plural cams are preferably disposed along the second direction.

The recording device of the present application further includes a protective cover located opposite to the base from the rising and lowering portion and that is configured to protect the lever, wherein an inclined surface, that is inclined in the vertically downward direction as leaving from the base, is preferably disposed on the vertically upward direction side of the protective cover.

### BRIEF DESCRIPTION OF THE DRAWINGS

FIG. 1 is a cross-sectional view illustrating a schematic configuration of a recording device according to an exemplary embodiment.

FIG. 2 is a front view illustrating a schematic configuration of a recording device according to an exemplary embodiment.

FIG. 3 is a perspective view illustrating a state of a winding unit.

FIG. 4 is a perspective view illustrating a state of a winding unit.

FIG. 5A is a perspective view illustrating a state of a first support mechanism.

FIG. 5B is a perspective view illustrating a state of a first support mechanism.

FIG. 6A is a perspective view illustrating a state of a first support mechanism.

FIG. 6B is a perspective view illustrating a state of a first support mechanism.

FIG. 7A is a perspective view illustrating a state of a first support mechanism.

FIG. 7B is a perspective view illustrating a state of a first support mechanism.

FIG. 8 is a perspective view illustrating a state of a first support mechanism.

FIG. 9 is a cross-sectional view of a placement portion taken along A-A in FIG. 5A.

FIG. 10 is a cross-sectional view of a placement portion taken along B-B in FIG. 5A.

FIG. 11 is a cross-sectional view of a second placement portion taken along B-B in FIG. 5A.

FIG. 12 is a perspective view illustrating a state in which a rolled medium is removed from the winding unit.

FIG. 13 is a perspective view illustrating a state in which a rolled medium is removed from the winding unit.

FIG. 14 is a perspective view illustrating a state in which a rolled medium is removed from the winding unit.

FIG. 15 is a perspective view illustrating a state in which the rolled medium is removed from the winding unit.

FIG. 16 is a cross-sectional view of a placement portion according to a comparative example.

FIG. 17 is a cross-sectional view of a second placement portion according to a comparative example.

### DESCRIPTION OF EXEMPLARY EMBODIMENTS

Exemplary embodiments of the present disclosure are described below with reference to the accompanying drawings. The exemplary embodiments each illustrate an aspect of the present disclosure, and do not limit the disclosure in any way. The exemplary embodiments can be changed as desired without departing from the scope of the technical concept of the present disclosure. Moreover, in each of the following figures, to make each layer, and each portion recognizable in terms of size, each layer and portion is illustrated at a scale different from an actual scale.

Exemplary Embodiment

Overview of Recording Device

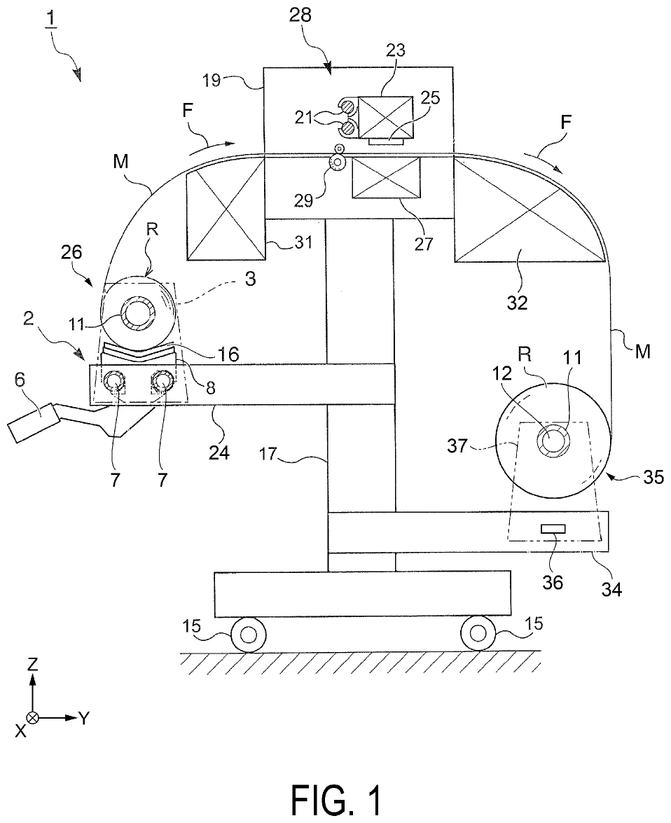

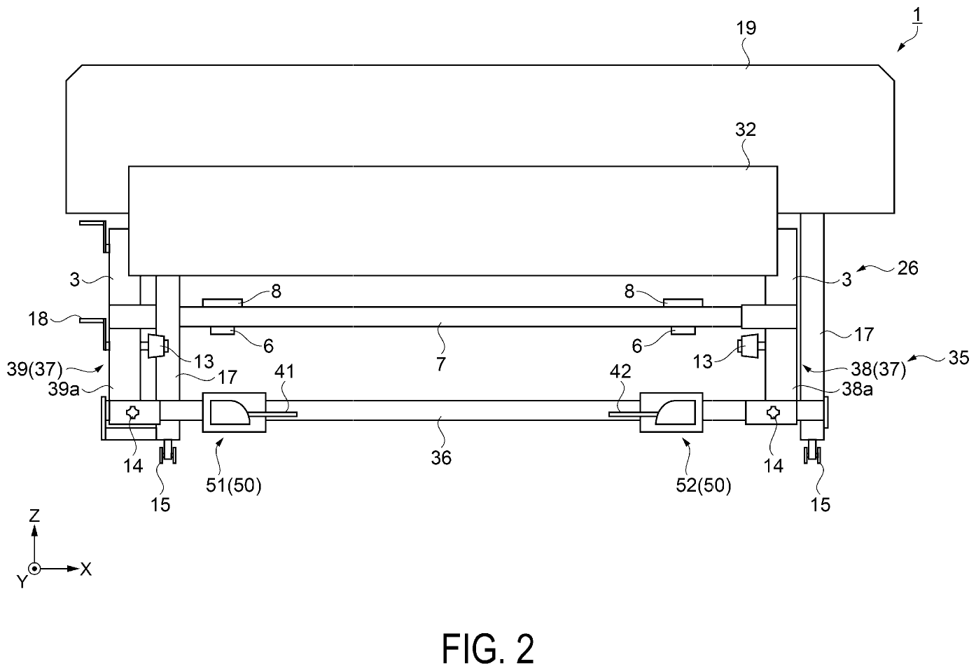

FIG. 1 is a cross-sectional view illustrating a schematic configuration of a recording device according to an exemplary embodiment. FIG. 2 is a front view illustrating a schematic configuration of the recording device according to the exemplary embodiment.

First of all, an overview of a recording device 1 according to the exemplary embodiment is described with reference to FIGS. 1 and 2.

As illustrated in FIGS. 1 and 2, the recording device 1 according to the exemplary embodiment is a large format printer (LFP) that handles long media M, and includes a pair of leg portions 17 each with a caster 15 attached to a bottom end, and a recording unit housing 19 assembled on the leg portions 17. Further, in the recording device 1, a feeding unit 26, a preheater 31, a roller pair 29, a recording unit 28, an afterheater 32, and a winding unit 35 are sequentially provided along a transport direction F of a medium M.

The feeding unit 26 is provided on a rear surface side of the recording device 1, located on the most upstream side in a transport path where the medium M is transported, and supported by the leg portions 17 via a holding portion 24. The feeding unit 26 includes a first holder portion 3 that supports a rolled medium R and a medium rising and lowering portion 2. The feeding unit 26 unwinds the medium M from the rolled medium R obtained by winding the medium M in a roll shape, and feeds the medium M to the roller pair 29.

The first holder portions 3 are disposed paired and face each other, and rotatably hold both end portions of the rolled medium R.

The medium rising and lowering portion 2 includes two guide rails 7, a base portion 8 that is slidable with respect to the guide rails 7, an operating lever 6, and a rising and lowering portion 16. By rotating the operating lever 6 in one direction, the rising and lowering portion 16 is rised and the rolled medium R can be lifted. Also, by rotating the operating lever 6 in the other direction, the rising and lowering portion 16 is lowered and the rolled medium R can be lowered. The medium rising and lowering portion 2 is configured based on lever principles, and it is possible to rise and lower, with a small force, the heavy rolled medium R.

An operator attaches the rolled medium R to the first holder portions 3 while adjusting a position of the rolled medium R by the medium rising and lowering portion 2.

The roller pair 29 is located downstream in the transport direction F with respect to the feeding unit 26, and provided inside the recording unit housing 19. The roller pair 29 transports the medium M fed out from the feeding unit 26 toward the recording unit 28.

The recording unit 28 is located downstream in the transport direction F with respect to the roller pair 29, and provided inside the recording unit housing 19. The recording unit 28 includes a carriage guide shaft 21 extending in a width direction of the medium M, a carriage 23, a recording head 25, and a medium support portion 27. The carriage 23 is provided to be movable reciprocally in the width direction of the medium M while being guided by the carriage guide shaft 21. The recording head 25 is mounted on the carriage 23 to face the medium support portion 27, and discharges ink or the like as a liquid toward the medium M while moving reciprocally. The medium support portion 27 supports the medium M and maintains a predetermined distance between the medium M and the recording head 25.

The recording device 1 records a desired image on the medium M by repeating the operation of the roller pair 29 transporting the medium M in the transport direction F and the operation of the recording head 25 discharging the ink onto the medium M while moving in the width direction of the medium M.

Note that the recording head 25 is a serial head mounted on the carriage 23 and configured to discharge the ink while moving in the width direction of the medium M. However, the recording head 25 may be a line head arranged to extend in the width direction of the medium M in a fixed state.

The preheater 31 is located upstream in the transport direction F with respect to the recording unit housing 19, and arranged between the feeding unit 26 and the roller pair 29. The preheater 31 facilitates drying of the ink that landed on the medium M during recording by heating the medium M before the recording for the medium is performed.

The afterheater 32 is located downstream in the transport direction F with respect to the recording unit housing 19, and arranged between the recording unit 28 and the winding unit 35. After the recording for the medium M has been performed, the afterheater 32 heats the medium M. As a result, the ink that landed on the medium M is dried until the medium M is wound by the winding unit 35.

The winding unit 35 is provided on the front side of the recording device 1, located on the most downstream side in the transport path where the medium M is transported, and supported by the leg portions 17 via a holding portion 34. The winding unit 35 forms the rolled medium R by winding the medium M in a roll shape, and holds the rolled medium R. The winding unit 35 includes a rail 36 extending in the width direction of the medium M, a support portion 37, and a support mechanism 50.

The support portion 37 supported by the rail 36, is movable in the width direction of the medium M, and supports the rolled medium R. The support mechanism 50 supported by the rail 36, is movable in the width direction of the medium M, and temporarily supports the rolled medium R when the rolled medium R is removed from the support portion 37.

In the following description, the width direction of the medium M is defined as an X direction. A direction intersecting the X direction is defined as a Y direction. A height direction of the recording device 1 is defined as a Z direction. Further, an arrow side of an arrow indicating the direction is defined as a (+) direction, and a base-end side of the arrow indicating the direction is defined as a (−) direction.

Note that the X (+) direction and the X (−) direction are one example of a “first direction”, and, in the following description, the X direction means the X (+) direction or the X (−) direction. The Y (+) direction and the Y (−) direction are one example of a “second direction”, and, in the following description, the Y direction means the Y (+) direction or the Y (−) direction. The Z (+) direction is one example of a “vertically upward direction”, and the Z (−) direction is one example of a “vertically downward direction”. Additionally, the Z (+) direction and the Z (−) direction are vertical directions. In addition, the X direction is the width direction of the recording device 1, and the Y direction is the depth direction of the recording device 1, and the X direction and the Y direction are each arranged on a horizontal plane.

Support Portion and Support Mechanism

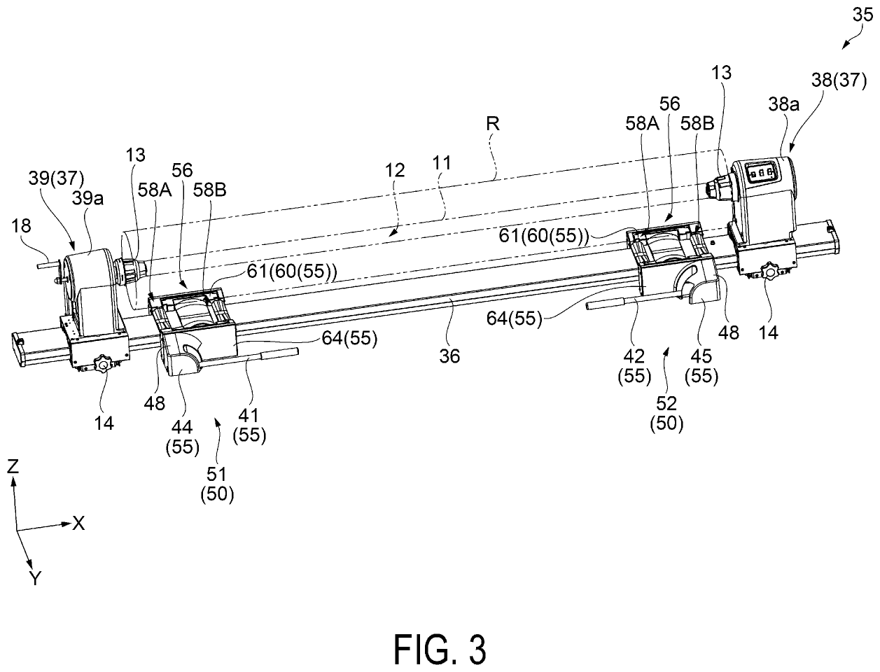

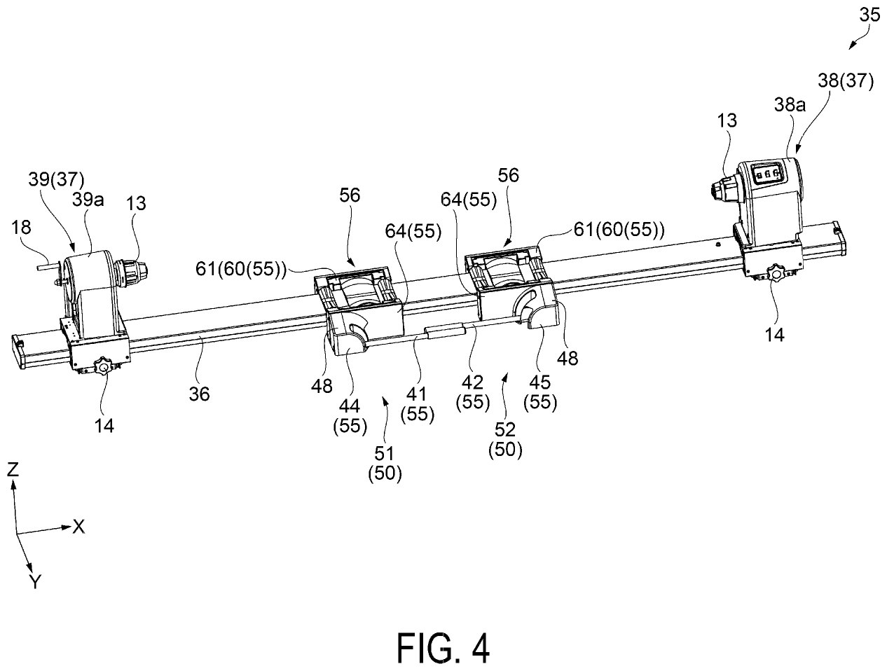

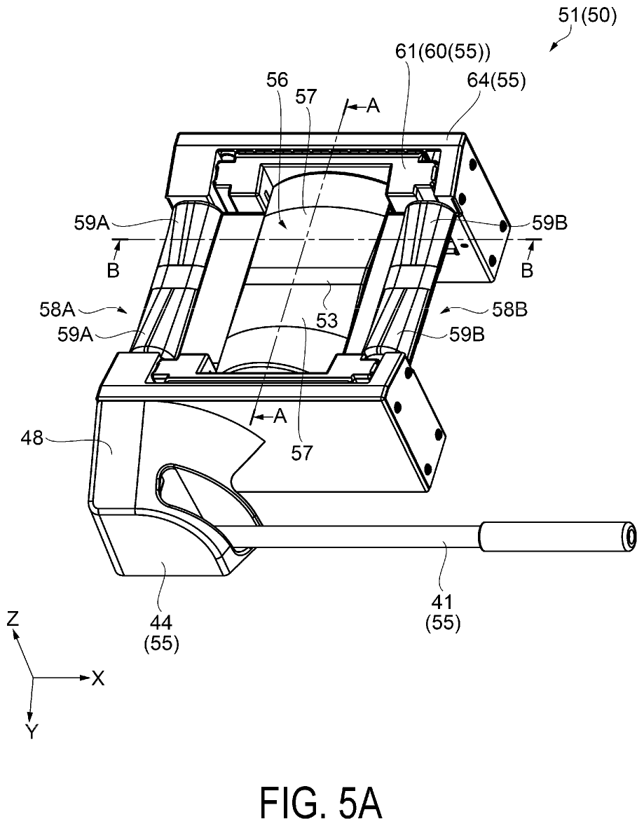

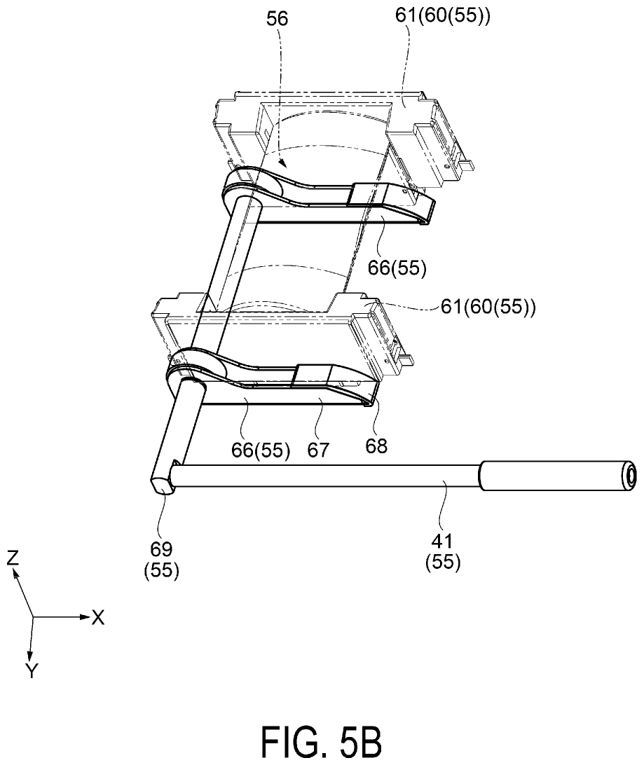

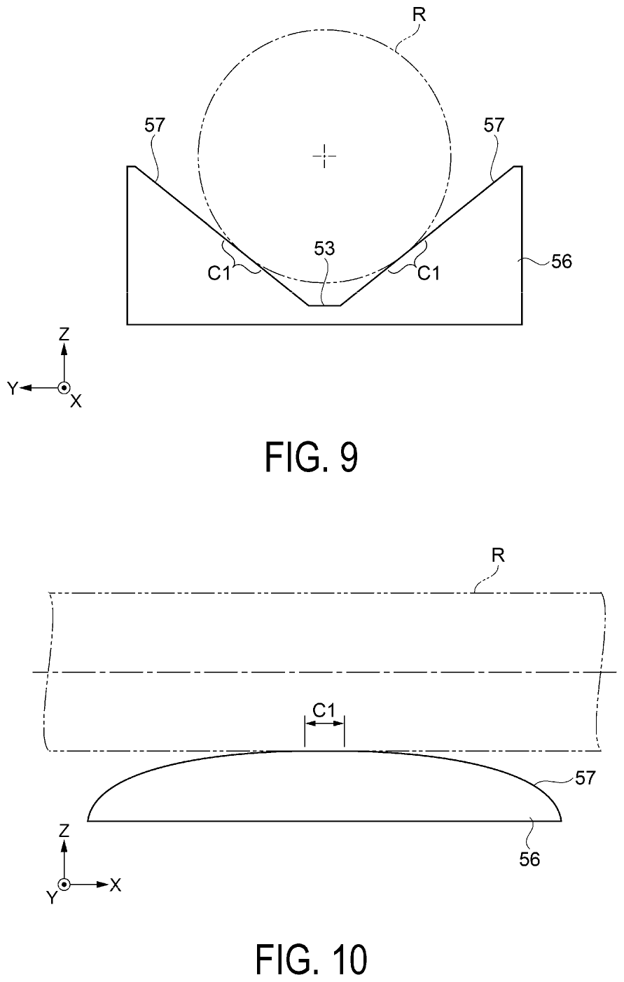

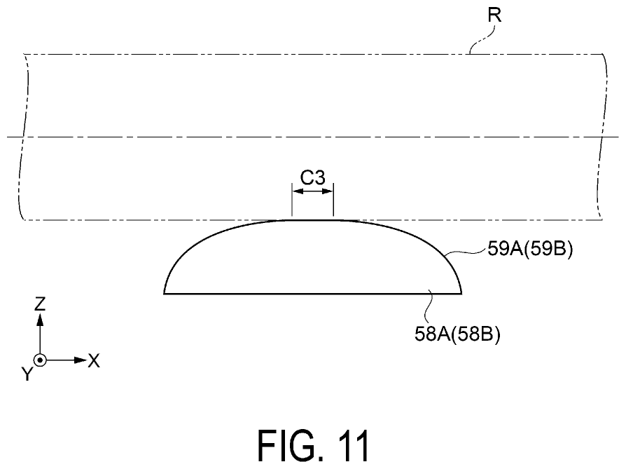

FIG. 3 and FIG. 4 are perspective views illustrating a state of a winding unit. FIGS. 5A to 8 are perspective views illustrating a state of a first support mechanism. FIG. 9 is a cross-sectional view of a placement portion taken along A-A in FIG. 5A. FIG. 10 is a cross-sectional view of the placement portion taken along B-B in FIG. 5A. FIG. 11 is a cross-sectional view of a second placement portion taken along B-B in FIG. 5A.

In FIG. 3, the rolled medium R is illustrated by a two-dot chain line. In FIG. 4, the rolled medium R is not illustrated. Also, in FIG. 3 and FIG. 4, a position of the support mechanism 50 (51, 52) is different.

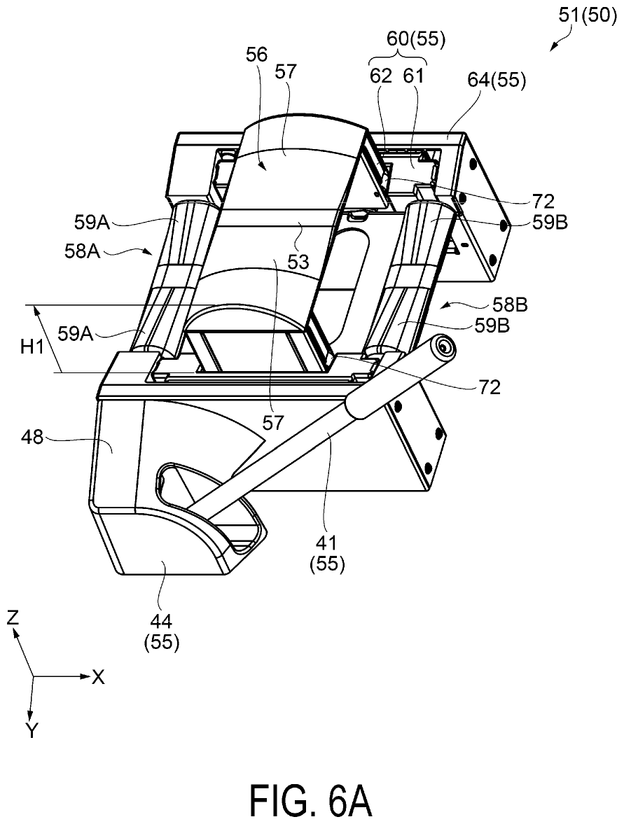

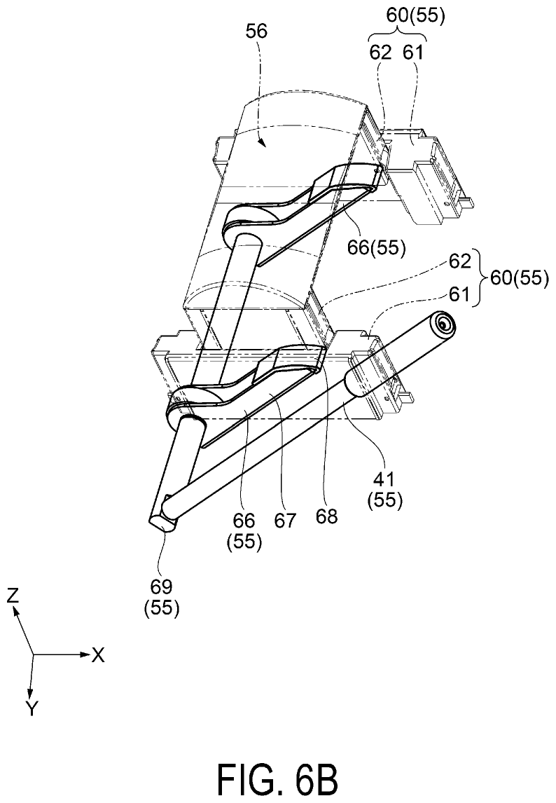

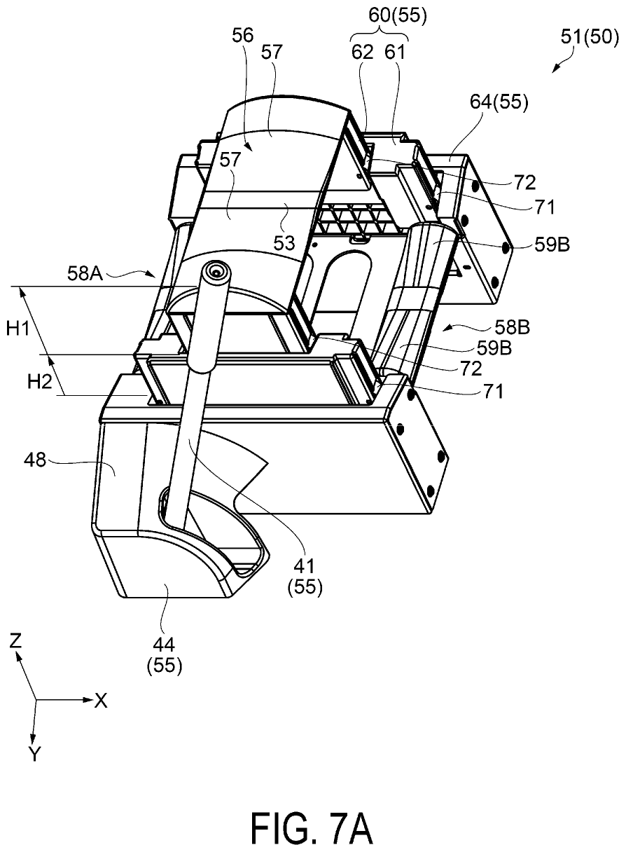

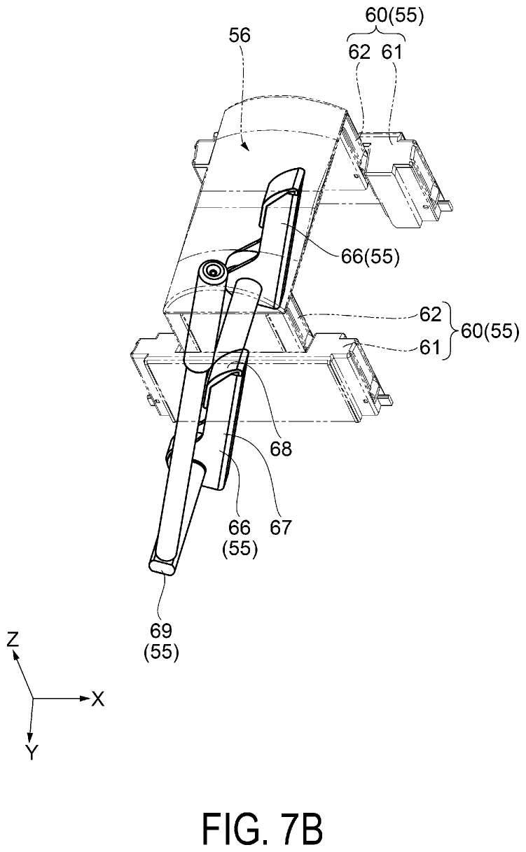

FIG. 5A, FIG. 6A, and FIG. 7A are perspective views illustrating a state of a first support mechanism 51. FIG. 5B, FIG. 6B, and FIG. 7B correspond to FIG. 5A, FIG. 6A, and FIG. 7A, and illustrate a part of components of the first support mechanism 51. Specifically, in FIG. 5B, FIG. 6B, and FIG. 7B, of the components of the first support mechanism 51, a first lever 41, a shaft 69, and a cam 66 are illustrated by solid lines, and a second rising and lowering portion 62 and a placement portion 56 are illustrated by a two-dot chain line.

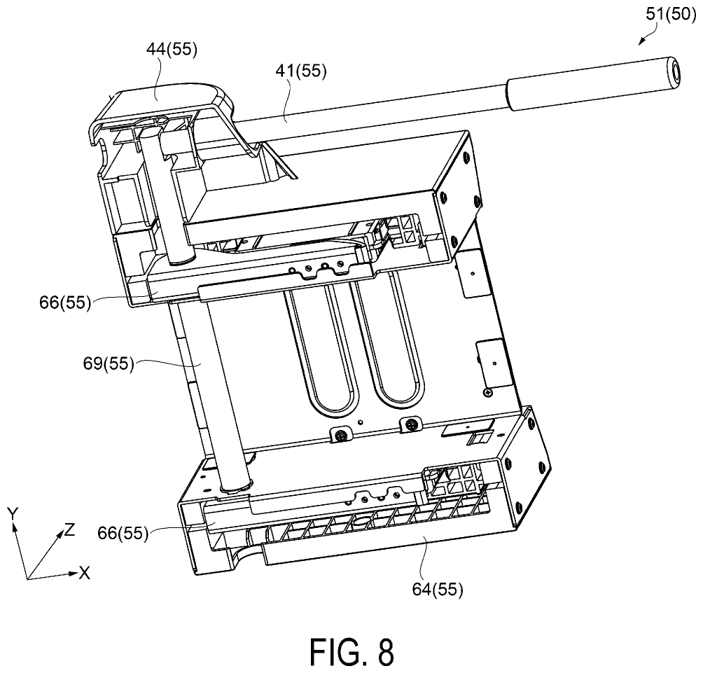

FIG. 5A is a perspective view of the first support mechanism 51 when the placement portion 56 is located on the Z (−) side, and hereinafter, the state illustrated in FIG. 5A is referred to as a lowered state. FIG. 7A is a perspective view of the first support mechanism 51 when the placement portion 56 is located on the Z (+) direction side, compared with FIG. 5A and FIG. 6A, and hereinafter, the state illustrated in FIG. 7A is referred to as a rised state. FIG. 6A is a perspective view of the first support mechanism 51 when the placement portion 56 is located between the state illustrated in FIG. 5A and the state illustrated in FIG. 7A, and hereinafter, the state illustrated in FIG. 6A is referred to as an intermediate state. FIG. 8 is a perspective view of the first support mechanism 51 in the lowered state when viewed from the back side (Z (−) direction side). FIG. 3 and FIG. 4 are perspective views of the winding unit 35 when the first support mechanism 51 is in the lowered state.

FIG. 9 to FIG. 11 illustrate a state in which the rolled medium R is placed on the placement portion 56 and second placement portions 58A and 58B, and the rolled medium R is illustrated by a two-dot chain line. FIG. 9 is a cross-sectional view of the placement portion 56 when viewed from the X direction, and FIG. 10 and FIG. 11 are cross-sectional views of the placement portion 56 or the second placement portions 58A and 58B when viewed from the Y direction intersecting the X direction.

Next, a state of the support portion 37 and the support mechanism 50 in the winding unit 35 will be described with reference to FIG. 3 to FIG. 11.

As illustrated in FIG. 3, the winding unit 35 includes the rail 36 extending in the X direction, a driving side support portion 38 (support portion 37) arranged on the X (+) direction side, a driven side support portion 39 (support portion 37) arranged on the X (−) direction side, the first support mechanism 51 (support mechanism 50) arranged on the X (−) direction side, and a second support mechanism 52 (support mechanism 50) arranged on the X (+) direction side. The driving side support portion 38, the driven side support portion 39, the first support mechanism 51, and the second support mechanism 52 are supported by the rail 36 and are each movable in the X direction.

The driving side support portion 38 includes a housing 38a, a fitting portion 13, a drive motor (not illustrated), and a gripping portion 14. The driven side support portion 39 includes a housing 39a, a fitting portion 13, a handle 18, and a gripping portion 14.

In the driving side support portion 38 and the driven side support portion 39, the fitting portion 13 has a substantially truncated conical shape to be easy to fit into a core opening 12 of a roll core 11, and a tip side of the fitting portion 13 is fitted into the core opening 12 of the roll core 11 of the rolled medium R. The support portion 37 (support portions 38 and 39) is movable along the rail 36 when the gripping portion 14 is loosened, and is fixed to the rail 36 when the gripping portion 14 is tightened.

In the winding unit 35, when the operator attaches the roll core 11 to the support portion 37, the operator first fits one side of the core opening 12 of the roll core 11 to the tip side of the fitting portion 13 of the driving side support portion 38. Next, the operator fits the other side of the core opening 12 of the roll core 11 to the tip side of the fitting portion 13 of the driven side support portion 39, turns the handle 18, and moves the fitting portion 13 of the driven side support portion 39 toward the driving side support portion 38. As a result, both ends of the roll core 11 are pressed by the fitting portions 13, and the roll core 11 is held rotatably by the support portions 37 (support portions 38 and 39).

Finally, when the tip end of the medium M unwound from the rolled medium R held in the feeding unit 26 is fixed to the roll core held in the support portions 37, the winding unit 35 can wind the medium M on which an image has been recorded into a roll shape to form the rolled medium R.

When the drive motor of the driving side support portion 38 is driven in a state in which both ends of the roll core 11 are held by the fitting portions 13 of the support portions 38 and 39, the fitting portion 13 of the driving side support portion 38 rotates in the direction in which the medium M is wound in a roll shape, and the fitting portion 13 of the driven side support portion 39 rotates in synchronization with the rotation of the fitting portion 13 of the driving side support portion 38. Then, in the winding unit 35, the medium M is wound in a roll shape, and the rolled medium R is formed.

That is, when the medium M on which a desired image is recorded is transported from the recording unit 28 in the transport direction F, the drive motor of the driving side support portion 38 is driven in the winding unit 35, and the medium M is wound in a roll shape.

The support mechanism 50 includes the first support mechanism 51 arranged on the X (−) direction side and the second support mechanism 52 arranged on the X (+) direction side. Each of the first support mechanism 51 and the second support mechanism 52 is supported by the rail 36 and movable in the X direction. The first lever 41 is provided on the first support mechanism 51. A second lever 42 is provided on the second support mechanism 52. Furthermore, the support mechanism 50 includes the placement portion 56 and the second placement portions 58A and 58B on which the rolled medium R is placed, a rising and lowering portion 60 that rises and lowers the placement portion 56, and a base 64 that houses the rising and lowering portion 60. The rising and lowering portion 60 is arranged inside the base 64.

The placement portion 56 is located between the second placement portion 58A and the second placement portion 58B, is supported by the rising and lowering portion 60, and has a position changed in the Z direction. The second placement portion 58A is located on the X (−) direction side with respect to the placement portion 56. The second placement portion 58B is located on the X (+) direction side with respect to the placement portion 56. Each of the second placement portions 58A and 58B is supported by the base 64 and has a position unchanged in the Z direction.

The first lever 41 and the second lever 42 are provided on the opposite side (Y (+) direction side with respect to the rising and lowering portion 60 of the base 64) with respect to the rising and lowering portion 60 of the base 64 in the Y direction, and the longitudinal direction of the first lever 41 and the second lever 42 intersects the Y direction. The first lever 41 and the second lever 42 are fixed to the shaft 69 (see FIG. 8) described below, and are rotatable with the shaft 69 serving as a fulcrum. Hereinafter, the first lever 41 and the second lever 42 are also referred to simply as a lever 41 and a lever 42, respectively.

In the exemplary embodiment, when the first support mechanism 51 is in the lowered state, the longitudinal direction of the levers 41 and 42 is orthogonal to the Y direction as viewed from the Z direction, and an angle formed between the longitudinal direction of the levers 41 and 42 and the Y direction is 90°. Note that, when the first support mechanism 51 is in the lowered state, the angle formed between the longitudinal direction of the levers 41 and 42 and the Y direction is not limited to 90°, but may be greater than 90° or smaller than 90°.

In the exemplary embodiment, when the first support mechanism 51 is in the lowered state, the longitudinal direction of the levers 41 and 42 extends in the X direction, and the levers 41 and 42 are each constituted by a single rod member. Note that the levers 41 and 42 may be constituted by two foldable rod members. When the levers 41 and 42 are constituted by two foldable rod members, the X-direction dimension of the levers 41 and 42 can be shortened with the first support mechanism 51 in the lowered state.

Further, when the longitudinal direction of the first lever 41 and the second lever 42 is arranged to intersect the Y direction, the Y-direction dimension of the support mechanism 50 (support mechanisms 51 and 52) can be shortened, and a dimension in the depth direction of the support mechanism 50 (support mechanisms 51 and 52) can be shortened, compared with a case where the longitudinal direction of the first lever 41 and the second lever 42 is arranged in parallel with the Y direction.

A position of the first lever 41 in the Y direction and a position of the second lever 42 in the Y direction are different. Thus, as illustrated in FIG. 4, even when the first support mechanism 51 is moved in the X (+) direction and the second support mechanism 52 is moved in the X (−) direction with respect to the state illustrated in FIG. 3, and an interval between the first support mechanism 51 and the second support mechanism 52 is reduced, the first lever 41 and the second lever 42 do not interfere with each other, and an interval between the first support mechanism 51 and the second support mechanism 52 can be reduced.

In the exemplary embodiment, the first support mechanism 51 can be moved close to the second support mechanism 52 such that the base 64 (housing) of the first support mechanism 51 contacts the base 64 (housing) of the second support mechanism 52.

The recording device 1 can process media M having different widths (dimensions in the X direction). The support mechanism 50 temporarily supports the rolled medium R when the rolled medium R is removed from the support portion 37. Thus, when a width of the medium M to be processed by the recording device 1 is changed, an interval between the first support mechanism 51 and the second support mechanism 52 also needs to be changed.

In a configuration in which an interval between the first support mechanism 51 and the second support mechanism 52 can be reduced by setting a position of the first lever 41 in the Y direction to be different from a position of the second lever 42 in the Y direction, a range of changes in interval between the first support mechanism 51 and the second support mechanism 52 increases, and a range of a width of the rolled medium R supportable by the support mechanism 50 (support mechanisms 51 and 52) increases.

In this way, the exemplary embodiment has the configuration in which a position in the Y direction of the first lever 41 is different from a position of the second lever 42 in the Y direction, and the first lever 41 and the second lever 42 do not interfere with each other when the first lever 41 and the second lever 42 rotate with the shaft 69 serving as a fulcrum.

In other words, a rotational trajectory of the first lever 41 is included in a first plane orthogonal to a rotational axis direction (Y direction), a rotational trajectory of the second lever 42 is included in a second plane orthogonal to the rotational axis direction (Y direction), and the first plane is offset with respect to the second plane in the rotational axis direction (Y direction).

Referring back to FIG. 3, a portion of the first lever 41 fixed to the shaft 69 is protected by a protective cover 44. A portion of the second lever 42 fixed to the shaft 69 is protected by a protective cover 45. In the support mechanisms 51 and 52, the levers 41 and 42 are provided on the opposite side from the rising and lowering portion 60 of the base 64.

As described above, the exemplary embodiment includes the protective covers 44 and 45 that are located on the opposite side from the rising and lowering portion 60 of the base 64 and protect the levers 41 and 42. Furthermore, an inclined surface 48 inclined in the Z (−) direction in a direction away from the base 64 is provided on the Z (+) direction side of the protective covers 44 and 45.

Since the first support mechanism 51 and the second support mechanism 52 have substantially the same configuration, the first support mechanism 51 will be mainly described hereinafter, and the description of the second support mechanism 52 will be omitted.

As illustrated in FIG. 5A to FIG. 8, the first support mechanism 51 includes the placement portion 56 and the second placement portions 58A and 58B that can support the rolled medium R from the Z (−) direction side, and a position adjustment unit 55 that rises the placement portion 56 in the Z (+) direction when the rolled medium R is removed from the support portion 37.

The second placement portion 58A is located on the X (−) direction side with respect to the placement portion 56, and the second placement portion 58B is located on the X (+) direction side with respect to the placement portion 56. The placement portion 56 and the second placement portions 58A and 58B are molded products of resin.

As illustrated in FIG. 9, when the placement portion 56 is viewed from the X direction, the placement portion 56 is a member having a substantially V-shaped cross section in which the vicinity of the center is recessed in the Z (−) direction and an end portion overhangs in the Z (+) direction. A bottom surface 53 is a portion recessed in the Z (−) direction in the vicinity of the center. A placement surface 57 is an inclined surface arranged between the portion (bottom surface 53) recessed in the Z (−) direction in the vicinity of the center and the end portion that overhangs in the Z (+) direction.

In this way, the placement surface 57, the bottom surface 53, and the placement surface 57 are arranged in order along the Y direction on the Z (+) direction side of the placement portion 56. When the rolled medium R is supported by the placement portion 56, the rolled medium R contacts the placement surface 57 and is placed on the placement surface 57.

The cross section of the rolled medium R is a circle, and a line passing through the center of the circle is a central axis of the rolled medium R. In FIG. 10, the rolled medium R is illustrated by a two-dot chain line, and the central axis of the rolled medium R is illustrated by a dot-dash line.

As illustrated in FIG. 10, when the placement portion 56 is viewed from the Y direction intersecting the X direction, the placement surface 57 on which the rolled medium R is placed is curved to be convex in the Z (+) direction. In other words, when the cross section along the X direction of the placement portion 56 is viewed in cross section, the placement surface 57 arranged on the Z (+) direction side of the placement portion 56 is curved to be convex in the Z (+) direction.

Note that, when the cross section along the X direction of the placement portion 56 is viewed in cross section, the placement surface 57 arranged on the Z (+) direction side of the placement portion 56 may be curved to be convex in the Z (+) direction. For example, the placement surface 57 may be curved to be convex in a direction toward the central axis of the rolled medium R illustrated by the dot-dash line in the drawing. For example, the placement surface 57 may be curved to be convex in a direction toward any of the ends along the X direction of the rolled medium R illustrated by the two-dot chain line in the drawing. For example, the placement surface 57 may be curved to be convex in a direction toward another portion.

In addition, when the rolled medium R is supported by the placement portion 56 in parallel with the X direction, the rolled medium R is placed on the placement surface 57 while contacting a top portion of the placement surface 57 in the highest position in the Z (+) direction. Furthermore, when the rolled medium R is placed on the placement surface 57, the rolled medium R deforms due to a dead weight of the rolled medium R or force provided from the placement surface 57, so that the rolled medium R comes into surface contact with a contact region C1 of the placement surface 57. That is, when a center line parallel to the Z direction through the center of the placement portion 56 in the X direction is considered, a shape of the placement portion 56 may not be symmetrical with respect to the center line as in FIG. 10 when viewed from the Y direction.

In FIG. 11, the rolled medium R is illustrated by a two-dot chain line, and the central axis of the rolled medium R is illustrated by a dot-dash line.

As illustrated in FIG. 11, when the second placement portions 58A and 58B are viewed from the Y direction intersecting the X direction, placement surfaces 59A and 59B on which the rolled medium R is placed are curved to be convex in the Z (+) direction similar to the placement portion 56. In other words, when the cross section along the X direction of the second placement portions 58A and 58B is viewed in cross section, the placement surfaces 59A and 59B arranged on the Z (+) direction side of the second placement portions 58A and 58B are curved to be convex in the Z (+) direction.

Note that, when the cross section along the X direction of the second placement portions 58A and 58B is viewed in cross section, the placement surfaces 59A and 59B arranged on the Z (+) direction side of the second placement portions 58A and 58B may be curved to be convex in the Z (+) direction. For example, the placement surfaces 59A and 59B may be curved to be convex in a direction toward the central axis of the rolled medium R illustrated by the dot-dash line in the drawing. For example, the placement surfaces 59A and 59B may be curved to be convex in a direction toward any of the ends along the X direction of the rolled medium R illustrated by the two-dot chain line in the drawing. For example, the placement surfaces 59A and 59B may be curved to be convex in a direction toward another portion. That is, when a center line parallel to the Z direction through the center of the second placement portions 58A and 58B in the X direction is considered, a shape of the placement portion 56 may not be symmetrical as in FIG. 11 with respect to the center line when viewed from the Y direction.

In addition, when the rolled medium R is supported by the second placement portions 58A and 58B in parallel with the X direction, the rolled medium R is placed on the placement surfaces 59A and 59B while contacting a top portion of the placement surfaces 59A and 59B in the highest position in the Z (+) direction. Furthermore, when the rolled medium R is placed on the placement surfaces 59A and 59B, the rolled medium R deforms due to a dead weight of the rolled medium R or force provided from the placement surfaces 59A and 59B, so that the rolled medium R comes into surface contact with a contact region C3 of the placement surfaces 59A and 59B.

The X-direction dimension of the placement surfaces 59A and 59B of the second placement portions 58A and 58B is shorter than the X-direction dimension of the placement surface 57 of the placement portion 56. Furthermore, the Z-direction dimension (height) of the placement surfaces 59A and 59B of the second placement portions 58A and 58B and the Z-direction dimension (height) of the placement surface 57 of the placement portion 56 are substantially the same.

Thus, the placement surfaces 59A and 59B of the second placement portions 58A and 58B have a greater degree of bending of the curved line than that of the placement surface 57 of the placement portion 56. In other words, when viewed from the Y direction intersecting the X direction, a radius of curvature of the placement surfaces 59A and 59B of the second placement portions 58A and 58B is smaller than a radius of curvature of the placement surface 57 of the placement portion 56.

Referring back to FIG. 5A to FIG. 8, the position adjustment unit 55 includes the base 64, the rising and lowering portion 60, the cam 66, the shaft 69, the first lever 41, and the protective cover 44. The base 64 and the rising and lowering portion 60 are molded products of resin.

The base 64 is an exterior member of the position adjustment unit 55 and houses the rising and lowering portion 60. Furthermore, the base 64 supports the second placement portions 58A and 58B. A position in the Z direction of the base 64 and a position in the Z direction of the second placement portions 58A and 58B are constant without changing.

The rising and lowering portion 60 includes a first rising and lowering portion 61 and a second rising and lowering portion 62, and is rised and lowered in the Z (+) direction or the Z (−) direction. Specifically, on the Y (+) direction side of the first support mechanism 51, the second rising and lowering portion 62 that supports the Y (+) direction end portion of the placement portion 56, and the first rising and lowering portion 61 that guides the rising and lowering of the second rising and lowering portion 62 are provided. On the Y (−) direction side of the first support mechanism 51, the second rising and lowering portion 62 that supports the Y (−) direction end portion of the placement portion 56, and the first rising and lowering portion 61 that guides the rising and lowering of the second rising and lowering portion 62 are provided. In this way, the two second rising and lowering portions 62 are arranged along the Y direction, and the two first rising and lowering portions 61 are arranged along the Y direction.

The first rising and lowering portion 61 is arranged inside the base 64. The first rising and lowering portion 61 has a recess (a U-shaped recess) in which both end portions bend in an L shape when viewed from the Z direction. The second rising and lowering portion 62 is arranged inside the recessed portion of the first rising and lowering portion 61. In other words, the second rising and lowering portion 62 is disposed inside the first rising and lowering portion 61. Then, the second rising and lowering portion 62 is rised and lowered along the recessed portion of the first rising and lowering portion 61, and the second rising and lowering portion 62 is rised and lowered with stability.

The shaft 69 is located on the Z (−) direction side with respect to the rising and lowering portion 60, and extends in the Y direction intersecting the X direction.

The cam 66 is a member that is arranged between the shaft 69 and the rising and lowering portion 60 and is long in one direction. The cam 66 that rises and lowers the second rising and lowering portion 62 supporting the Y (+) direction end portion of the placement portion 56 is provided on the Y (+) direction side of the first support mechanism 51, and the cam 66 that rises and lowers the second rising and lowering portion 62 supporting the Y (−) direction end portion of the placement portion 56 is provided on the Y (−) direction side of the first support mechanism 51. In this way, the two cams 66 are arranged along the Y direction.

One end of the cam 66 is fixed to the shaft 69 and the other end of the cam 66 is arranged to contact the second rising and lowering portion 62. The cam 66 is rotatable with the shaft 69 serving as a fulcrum, and adjusts a position in the Z direction of the second rising and lowering portion 62. As described above, the first lever 41 is rotatable with the shaft 69 serving as a fulcrum. The cam 66 rotates with the shaft 69 serving as a fulcrum in synchronization with the rotational movement of the first lever 41.

When the cam 66 rotates such that the longitudinal direction of the cam 66 moves from the X direction toward the Z direction by the rotation of the cam 66, the second rising and lowering portion 62 is rised in the Z (+) direction as the rotation of the cam 66. When the cam 66 rotates such that the longitudinal direction of the cam 66 moves from the X direction toward the Z direction by the rotation of the cam 66, the second rising and lowering portion 62 is lowered in the Z (−) direction as the rotation of the cam 66. In this way, the second rising and lowering portion 62 (the rising and lowering portion 60) supports the placement portion 56 and is rised and lowered in the Z (+) direction or the Z (−) direction by the rotation of the cam 66.

In the exemplary embodiment, the two second rising and lowering portion 62 arranged along the Y direction are rised and lowered by the rotation of the two cams 66 arranged along the Y direction. In this way, the force that rises and lowers the placement portion 56 acts on both end portions in the Y direction of the placement portion 56, and the placement portion 56 is rised and lowered. For example, a configuration is also conceivable in which the force that rises and lowers the placement portion 56 acts on a center portion in the Y direction of the placement portion 56 by rising and lowering the one second rising and lowering portion 62 by the rotation of the one cam 66, and the placement portion 56 is rised and lowered.

Compared with a configuration in which the force that rises and lowers the placement portion 56 acts on the center portion in the Y direction of the placement portion 56, a posture of the placement portion 56 is stable and the placement portion 56 is rised and lowered with stability in the configuration (the configuration of the exemplary embodiment) in which the force that rises and lowers the placement portion 56 acts on both end portions in the Y direction of the placement portion 56.

Therefore, the two cams 66 are preferably arranged along the Y direction such that the force that rises and lowers the placement portion 56 acts on both end portions of the placement portion 56.

Note that the number of the cams 66 arranged along the Y direction may be a plurality, and may be three or more, for example.

Further, in the first support mechanism 51, the operator rotates the first lever 41 with the shaft 69 serving as a fulcrum, the rotational movement of the first lever 41 is then converted into rotation of the cam 66, and the placement portion 56 supported by the second rising and lowering portion 62 is rised and lowered in the Z (+) direction or the Z (−) direction. When the rolled medium R is placed on the placement portion 56, a portion of the first lever 41 to which force is applied by the operator becomes a force point, and a portion (contact portion 68) of the cam 66 that contacts the second rising and lowering portion 62 becomes an action point to which force supporting the rolled medium R is applied, and the shaft 69 serves as a fulcrum supporting the force point (first lever 41) and the action point (cam 66). In other words, the first support mechanism 51 is provided with a lever formed from the force point (first lever 41), the fulcrum (shaft 69), and the action point (cam 66).

The operator can use the lever to rise and lower the rolled medium R in the Z (+) direction or the Z (−) direction, so that a burden on the operator is reduced further than that when the lever is not used.

In the lowered state, as illustrated in FIG. 5B, an inclination of the cam 66 with respect to the X direction is gentle, and the second rising and lowering portion 62 and the placement portion 56 are not rised in the Z (+) direction.

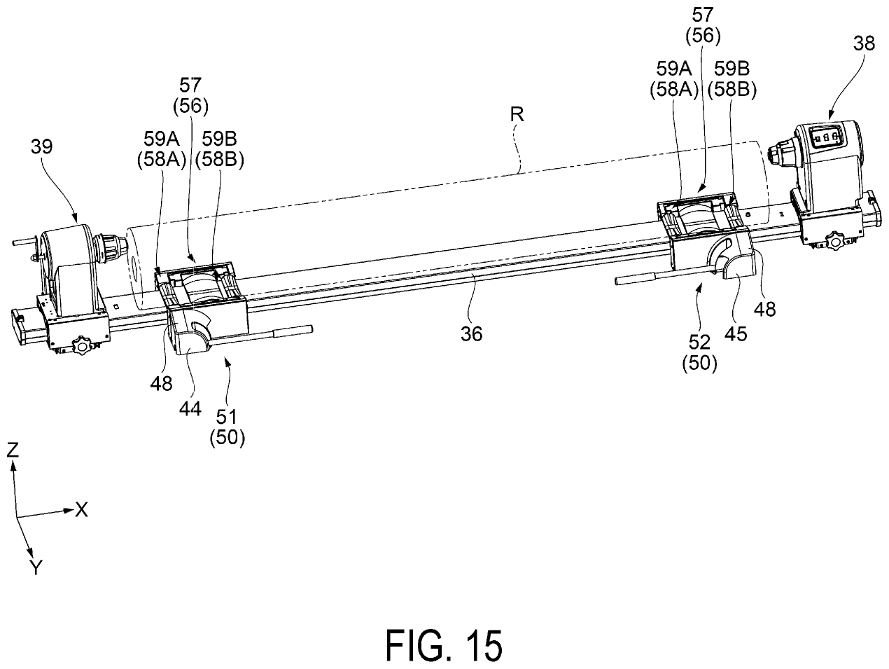

For example, as illustrated in FIG. 15, when the rolled medium R is supported in parallel with the X direction by the support mechanisms 51 and 52, positions of the placement portion 56 and the second placement portions 58A and 58B are adjusted such that the rolled medium R is supported by the placement portion 56 and the second placement portions 58A and 58B.

In the intermediate state, as illustrated in FIG. 6B, an inclination of the cam 66 with respect to the X direction is steeper than that in the lowered state, and the portion of the cam 66 that contacts the second rising and lowering portion 62 is rised in the Z (+) direction. When the first support mechanism 51 changes from the lowered state to the intermediate state, the second rising and lowering portion 62 is rised from a position in the lowered state by a distance H1. Then, the placement portion 56 supported by the second rising and lowering portion 62 is also rised from a position in the lowered state by the distance H1.

Note that, in the intermediate state, the first rising and lowering portion 61 is not rised in the Z (+) direction.

In the intermediate state, the second rising and lowering portion 62 and the first rising and lowering portion 61 are engaged with each other. Thus, when the second rising and lowering portion 62 attempts to be further rised in the Z (+) direction from a position in the intermediate state, the first rising and lowering portion 61 is rised in the Z (+) direction along with the second rising and lowering portion 62.

Note that, when the second rising and lowering portion 62 is lowered in the Z (−) direction from the position in the intermediate state, the engagement between the second rising and lowering portion 62 and the first rising and lowering portion 61 is released, and only the second rising and lowering portion 62 is lowered in the Z (−) direction.

In the rised state, as illustrated in FIG. 7B, an inclination of the cam 66 with respect to the X direction is further steeper than that in the intermediate state, and the second rising and lowering portion 62 is further rised in the Z (+) direction by a distance H2. In this case, the first rising and lowering portion 61 is rised in the Z (+) direction along with the second rising and lowering portion 62.

When the first support mechanism 51 changes from the intermediate state to the rised state, the first rising and lowering portion 61 is rised from the position in the lowered state by the distance H2, and the second rising and lowering portion 62 is rised from the position in the lowered state by a distance (H1+H2). Then, the placement portion 56 supported by the second rising and lowering portion 62 is also rised from the position in the lowered state by the distance (H1+H2).

As described above, the exemplary embodiment has the configuration in which the second rising and lowering portion 62 and the placement portion 56 are rised in two steps. When the exemplary embodiment has the configuration in which the second rising and lowering portion 62 and the placement portion 56 are rised in two steps, if a dimension in the Z direction of the second rising and lowering portion 62 is approximately H1 and a dimension in the Z direction of the first rising and lowering portion 61 is approximately H2, the second rising and lowering portion 62 and the placement portion 56 can be rised from positions in the initial state by the distance (H1+H2).

For example, in a configuration in which the first rising and lowering portion 61 is not provided and the second rising and lowering portion 62 and the placement portion 56 are rised by the distance (H1+H2) in one step, a dimension in the Z direction of the second rising and lowering portion 62 needs to be approximately (H1+H2) or greater.

In contrast, the configuration of the exemplary embodiment (the configuration in which the second rising and lowering portion 62 and the placement portion 56 are rised in two steps) can reduce a dimension in the Z direction of the second rising and lowering portion 62 further than that in the configuration in which the second rising and lowering portion 62 and the placement portion 56 are rised in one step. Therefore, the configuration of the exemplary embodiment (the configuration in which the second rising and lowering portion 62 and the placement portion 56 are rised in two steps) makes it possible to reduce a dimension in the Z direction of the first support mechanism 51 in the lowered state and reduce a height of the first support mechanism 51.

As illustrated in FIG. 5B, FIG. 6B, and FIG. 7B, the cam 66 includes a body 67 and the contact portion 68. The body 67 is made of metal, and the contact portion 68 is made of resin.

The body 67 is a member that is long in one direction and is a strut that supports the second rising and lowering portion 62 and the placement portion 56. When the rolled medium R is placed on the placement portion 56, a load of the rolled medium R acts on the body 67. When the body 67 is made of metal, mechanical strength is increased further than that of the body 67 made of resin, and even with the rolled medium R having a great weight, the body 67 can appropriately support the placement portion 56. In other words, even when a large load acts on the body 67, defects such as deformation are less likely to occur.

The contact portion 68 is arranged on the portion of the cam 66 that contacts the second rising and lowering portion 62, that is, between the body 67 and the second rising and lowering portion 62. When the state of the first support mechanism 51 changes to any of the lowered state, the intermediate state, and the rised state, the second rising and lowering portion 62 is rised and lowered in the Z (+) direction or the Z (−) direction, and sliding between the cam 66 and the second rising and lowering portion 62 occurs.

In a case where the contact portion 68 is not provided on the portion of the cam 66 that contacts the second rising and lowering portion 62 and the body 67 made of metal directly contacts the second rising and lowering portion 62, the second rising and lowering portion 62 made of resin wears, and it becomes difficult to rise and lower the second rising and lowering portion 62 with stability.

In the exemplary embodiment, the contact portion 68 made of resin is provided on the portion of the cam 66 that contacts the second rising and lowering portion 62. Therefore, the second rising and lowering portion 62 made of resin is less likely to wear, and the second rising and lowering portion 62 is rised and lowered with stability.

A constituent material of the contact portion 68 is preferably a resin having excellent wear resistance and having excellent self-lubricating properties with a low coefficient of friction. For example, polyacetal (POM) can be used as a constituent material of the contact portion 68. In addition to POM, Teflon® with excellent self-lubricating properties can be used as a construction material of the contact portion 68.

In this way, in the exemplary embodiment, the contact member 68 made of resin is arranged between the body 67 and the second rising and lowering portion 62. Therefore, compared with the configuration in which the body 67 made of metal directly contacts the second rising and lowering portion 62, the second rising and lowering portion 62 is less likely to wear, and the lifespan of the first support mechanism 51 can be extended.

In the first support mechanism 51, a rolling body 71 is provided between the base 64 and the first rising and lowering portion 61, and a rolling body 72 is provided between the first rising and lowering portion 61 and the second rising and lowering portion 62.

The rolling body 71 is rotatably attached to the first rising and lowering portion 61, and a rolling surface of the rolling body 71 contacts the base 64. The rolling body 72 is rotatably attached to the second rising and lowering portion 62, and a rolling surface of the rolling body 72 contacts the first rising and lowering portion 61.

As illustrated in FIG. 6A, when the second rising and lowering portion 62 is rised in the Z (+) direction, the second rising and lowering portion 62 is rised while the rolling body 72 rotates, and thus the second rising and lowering portion 62 can be rised more smoothly than that in a configuration in which the rolling body 72 is not provided.

As illustrated in FIG. 7A, when the first rising and lowering portion 61 is rised in the Z (+) direction, the first rising and lowering portion 61 is rised while the rolling body 71 rotates, and thus the first rising and lowering portion 61 can be rised more smoothly than that in a configuration in which the rolling body 71 is not provided.

Removal of Rolled Medium in Winding Unit

In the recording device 1, when all of the medium M is unwound from the feeding unit 26 and wound around the winding unit 35, the roll core 11 is removed from the feeding unit 26, a new rolled medium R is attached to the feeding unit 26, the rolled medium R on which recording processing has been performed is removed from the winding unit 35, a new roll core 11 is attached to the winding unit 35, and the recording processing is resumed.

When the new rolled medium R is attached to the feeding unit 26 and the rolled medium R on which the recording processing has been performed is removed from the winding unit 35, the recording device 1 cannot perform the recording processing, and a stop loss is generated in the recording device 1 where the recording processing cannot be performed.

When a period of time from attachment of the new rolled medium R to the feeding unit 26 until attachment of a next new rolled medium R to the feeding unit 26 is increased, that is, a period of time from attachment of the new rolled medium R to the feeding unit 26 until removal of the rolled medium R on which the recording processing has been performed from the winding unit 35 is increased, an influence of a stop loss in the recording device 1 can be reduced, and the productivity of the recording device 1 can be increased.

For example, when the amount of the medium M wound on the rolled medium R is increased, a period of time from attachment of the new rolled medium R to the feeding unit 26 until attachment of next new rolled medium R to the feeding unit 26 increases. This is also referred to as so-called continuous printing, and examples include a plurality of jobs being input to the recording device 1 to allow the recording device 1 to perform unmanned operation for an extended period of time. As a result, the frequency of attaching the rolled medium R to the feeding unit 26 can be reduced. During attachment of the rolled medium R to the feeding unit 26, the recording device 1 does not perform the recording processing, which thus results in so-called downtime for the recording device 1. Thus, by performing continuous printing, the frequency of attaching the rolled medium R to the feeding unit 26 is reduced, and the downtime is suppressed, so that the productivity of the recording device 1 can be increased.

For the reasons described above, the amount of the medium M wound on the rolled medium R tends to increase in order to increase the productivity of the recording device 1. In addition, a larger width of the medium M increases a weight of the rolled medium R, and it may become difficult for one operator to remove the rolled medium R from the winding unit 35.

For example, in the recording device 1 according to the exemplary embodiment, a rolled medium R having a width of approximately 64 inches, a diameter of approximately 300 mm, and a weight of approximately 60 kg may be used.

When the rolled medium R having a weight of approximately 60 kg is used, it becomes difficult for the operator to remove the rolled medium R from the winding unit 35. Specifically, since the winding unit 35 is located below the recording device 1, the operator is brought into a bent state when removing the rolled medium R from the winding unit 35. When the operator in this state attempts to carry up the rolled medium R having a weight of approximately 60 kg, a large burden on the operator's waist or the like may be imposed.

The recording device 1 according to the exemplary embodiment has an excellent advantage that the operation of removing the rolled medium R from the winding unit 35 is made efficient by providing the support mechanism 50 on the winding unit 35 side, and by allowing the operator to use the support mechanism 50 and remove the rolled medium R from the winding unit 35. Accordingly, the details thereof are described below.

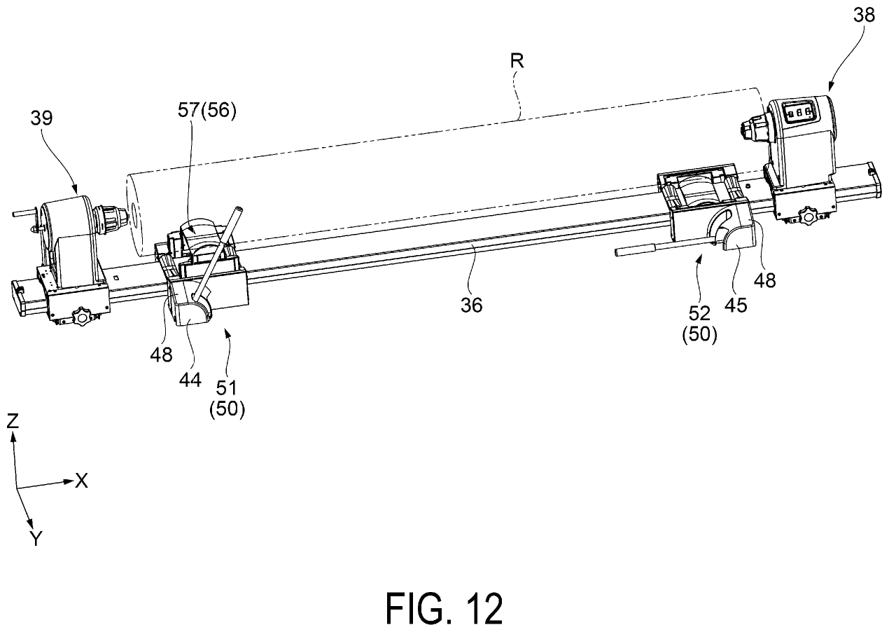

FIG. 12 to FIG. 15 are views corresponding to FIG. 3, and are perspective views illustrating a state in which the rolled medium is removed from the winding unit.

Next, the operation of removing the rolled medium R from the winding unit 35 will be described with reference to FIG. 3 and FIG. 12 FIG. 15.

When all of the medium M is wound around the winding unit 35, the winding unit 35 is in the state illustrated in FIG. 3, the first support mechanism 51 and the second support mechanism 52 are in the lowered state, and the placement portion 56 and the second placement portions 58A and 58B are arranged away from the rolled medium R. In other words, the operation of removing the rolled medium R from the winding unit 35 is started from a state (the state illustrated in FIG. 3) in which the placement portion 56 and the second placement portions 58A and 58B are arranged away from the rolled medium R.

As illustrated in FIG. 12, when removing the rolled medium R from the winding unit 35, first, the operator brings the first support mechanism 51 into the rised state, moves the driven side support portion 39 in the X (−) direction while the rolled medium R on the driven side support portion 39 side is supported by the first support mechanism 51, and separates the driven side support portion 39 from the rolled medium R.

In the state illustrated in FIG. 12, the rolled medium R is supported by the first support mechanism 51 in the rised state and the driving side support portion 38. In this case, the rolled medium R is in a state parallel to the X direction and supported by the first support mechanism 51 in the rised state. As a result, the rolled medium R is supported by the contact region C1 (see FIG. 10) of the placement surface 57 of the placement portion 56 on the first support mechanism 51 side.

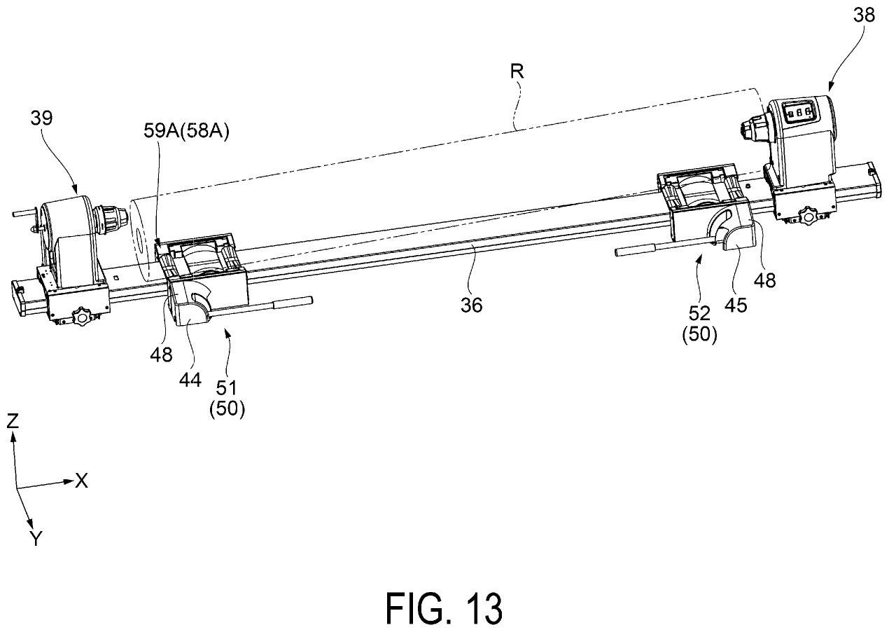

As illustrated in FIG. 13, the operator then brings the first support mechanism 51 into the lowered state.

In the state illustrated in FIG. 13, the rolled medium R is supported by the first support mechanism 51 in the lowered state and the driving side support portion 38. In this case, in the Z direction, the rolled medium R is low on the first support mechanism 51 side, is high on the driving side support portion 38 side, and intersects (inclines) with respect to the X direction. As a result, the rolled medium R is supported by the contact region C3 (see FIG. 11) of the placement surface 59A of the second placement portion 58A on the first support mechanism 51 side.

Note that, when the rolled medium R is inclined with respect to the X direction, a position of the region, in which the rolled medium R is supported, of the placement surface 59A of the second placement portion 58A on the first support mechanism 51 side changes, compared with a case where the rolled medium R is parallel to the X direction. However, since a change in the position of the region in which the rolled medium R is supported is slight, the rolled medium R can be considered to be substantially supported by the contact region C3 of the placement surface 59A of the second placement portion 58A on the first support mechanism 51 side.

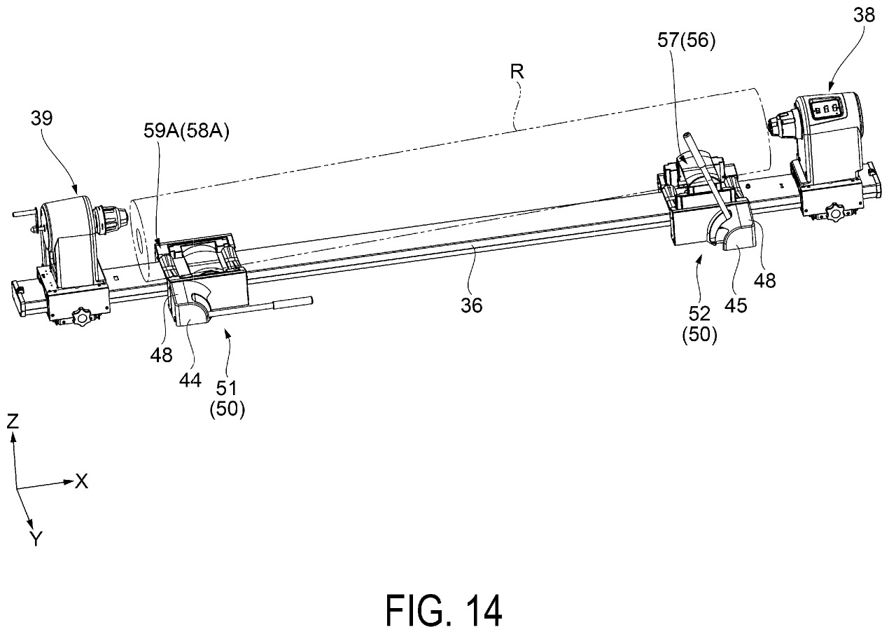

As illustrated in FIG. 14, the operator then brings the second support mechanism 52 into the rised state, moves the driving side support portion 38 while the rolled medium R on the driving side support portion 38 side is supported by the second support mechanism 52, and separates the driving side support portion 38 from the rolled medium R.

In the state illustrated in FIG. 14, the rolled medium R is supported by the first support mechanism 51 in the lowered state and the second support mechanism 52 in the rised state. In this case, the rolled medium R is low on the first support mechanism 51 side, is high on the second support mechanism 52 side, and intersects (incline) with respect to the X direction. Then, the rolled medium R is supported by the contact region C3 of the placement surface 59A of the second placement portion 58A on the first support mechanism 51 side and the contact region C1 of the placement surface 57 of the placement portion 56 on the second support mechanism 52 side.

Note that, when the rolled medium R is inclined with respect to the X direction, a position of the region, in which the rolled medium R is supported, of the placement surface 57 of the placement portion 56 on the second support mechanism 52 side changes, compared with a case where the rolled medium R is parallel to the X direction. However, since a change in the position of the region in which the rolled medium R is supported is slight, the rolled medium R can be considered to be substantially supported by the contact region C1 of the placement surface 57 of the placement portion 56 on the second support mechanism 52 side.

As illustrated in FIG. 15, the operator then brings the second support mechanism 52 into the lowered state. In the state illustrated in FIG. 15, the rolled medium R is supported by the first support mechanism 51 in the lowered state and the second support mechanism 52 in the lowered state. In this case, the rolled medium R is in a state parallel to the X direction, and supported by the contact region C1 of the placement surface 57 of the placement portion 56 on the first support mechanism 51 side, the contact region C3 of the placement surfaces 59A and 59B of the second placement portions 58A and 58B on the first support mechanism 51 side, the contact region C1 of the placement surface 57 of the placement portion 56 on the second support mechanism 52 side, and the contact region C3 of the placement surfaces 59A and 59B of the second placement portions 58A and 58B on the second support mechanism 52 side.

Although not illustrated, the operator then pushes the rolled medium R in the Y (+) direction. Since the rolled medium R has a cylindrical shape, the rolled medium R moves toward the protective covers 44 and 45 while rotating when the operator presses the rolled medium R in the Y (+) direction. When the rolled medium R reaches the protective covers 44 and 45, the rolled medium R rolls along the inclined surface 48 provided on the Z (+) direction side of the protective covers 44 and 45 by gravity acting in the Z (−) direction, is automatically discharged to the outside of the winding unit 35, and is placed on a lifter (not illustrated) arranged outside the winding unit 35.

In this way, when the operator moves the rolled medium R toward the protective covers 44 and 45 while rotating the rolled medium R, the rolled medium R is automatically discharged to the outside of the winding unit 35. Thus, the operator can easily place the rolled medium R on the lifter. In addition, the operation of carrying the rolled medium R is not needed, and a burden on the operator when removing the rolled medium R from the winding unit 35 can be reduced.

As described above, in the operation of removing the rolled medium R from the winding unit 35, the operator may carry one of both end portions of the rolled medium R in the Z (+) direction by using the first support mechanism 51 or the second support mechanism 52. Compared with a case where the entire rolled medium R is lifted in the Z (+) direction, a burden on the operator can be reduced, and the rolled medium R can be efficiently removed from the winding unit 35.

The first support mechanism 51 and the second support mechanism 52 are each provided with the lever formed from the force point (levers 41 and 42), the fulcrum (shaft 69), and the action point (cam 66). The operator can rise and lower the rolled medium R in the Z (+) direction or the Z (−) direction by the lever, so that a burden on the operator is reduced further than that when the lever is not used.

Additionally, a burden on the operator when lifting one of both end portions of the rolled medium R in the Z (+) direction varies depending on a length of the levers 41 and 42 (distance between the force point and the fulcrum). A greater length of the levers 41 and 42 reduces a burden on the operator, and a shorter length of the levers 41 and 42 increases a burden on the operator.

In the exemplary embodiment, a length of the levers 41 and 42 is set such that one operator can lift one of both end portions of the rolled medium R in the Z (+) direction. As a result, the operator can easily remove the rolled medium R from the winding unit 35, and a burden on the operator can be reduced when the rolled medium R is removed from the winding unit 35.

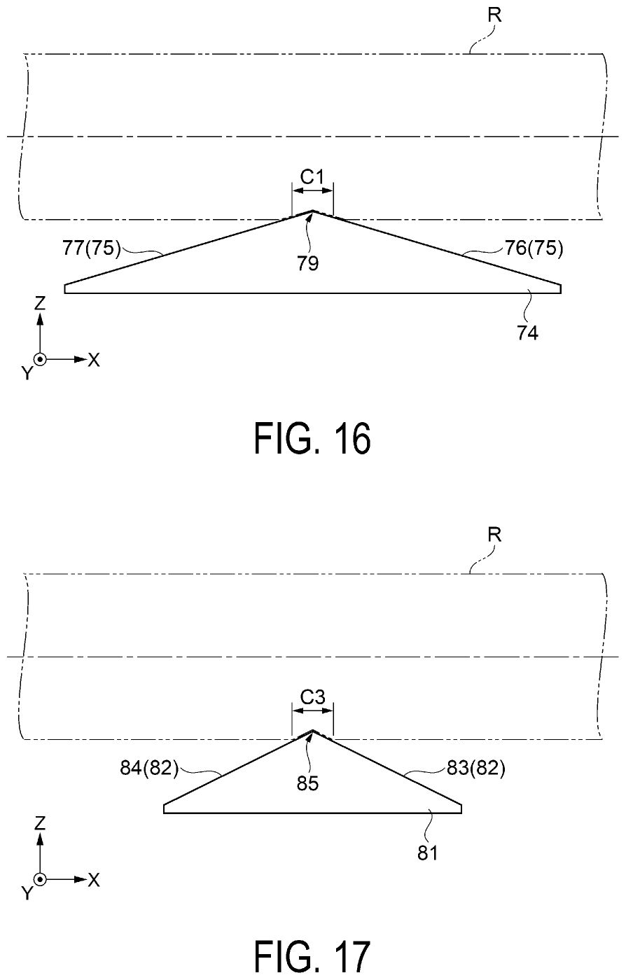

FIG. 16 is a view corresponding to FIG. 10, and is a cross-sectional view of a placement portion according to a comparative example.

The placement surface 57 of the placement portion 56 according to the exemplary embodiment is constituted by a curved surface that is curved to be convex in the Z (+) direction when viewed from the Y direction intersecting the X direction. On the other hand, a placement surface 75 of a placement portion 74 according to the comparative example is constituted by an inclined flat surface (inclined surfaces 76 and 77) to be convex in the Z (+) direction when viewed from the Y direction intersecting the X direction. This is a difference between the placement portion 56 according to the exemplary embodiment and the placement portion 74 according to the comparative example.

FIG. 17 is a view corresponding to FIG. 11, and is a cross-sectional view of a second placement portion according to a comparative example.

The placement surfaces 59A and 59B of the second placement portion 58A and 58B according to the exemplary embodiment are each constituted by a curved surface that is curved to be convex in the Z (+) direction when viewed from the Y direction intersecting the X direction. On the other hand, a placement surface 82 of a second placement portion 81 according to the comparative example is constituted by an inclined flat surface (inclined surfaces 83 and 84) to be convex in the Z (+) direction when viewed from the Y direction intersecting the X direction. This is a difference between the second placement portions 58A and 58B according to the exemplary embodiment and the second placement portion 81 according to the comparative example.

As illustrated in FIG. 16, the placement surface 75 of the placement portion 74 according to the comparative example is constituted by the two inclined surfaces 76 and 77 to be convex in the Z (+) direction. The inclined surface 76 is arranged on the X (+) direction side, and the inclined surface 77 is arranged on the X (−) direction side.

When the placement portion 74 according to the comparative example is viewed from the Y direction, the placement portion 74 has a triangular cross section. The placement surface 75 includes a corner portion 79 that is an apex of the triangle and pointed in the Z (+) direction. The corner portion 79 is located at a boundary between the inclined surface 76 and the inclined surface 77, is a ridge line of a top portion of the placement portion 74, and extends in the Y direction.

As illustrated in FIG. 17, the placement surface 82 of the second placement portion 81 according to the comparative example is constituted by the two inclined surfaces 83 and 84 to be convex in the Z (+) direction. The inclined surface 83 is arranged on the X (+) direction side, and the inclined surface 84 is arranged on the X (−) direction side.

When the second placement portion 81 according to the comparative example is viewed from the Y direction, the second placement portion 81 has a triangular cross section. The placement surface 82 includes a corner portion 85 that is an apex of the triangle and pointed in the Z (+) direction. The corner portion 85 is located at a boundary between the inclined surface 83 and the inclined surface 84, is a ridge line of a top portion of the second placement portion 81, and extends in the Y direction.

Furthermore, the inclined surfaces 83 and 84 of the second placement portion 81 are steeper than the inclined surfaces 76 and 77 of the placement portion 74. Thus, the corner portion 85 of the second placement portion 81 is pointed to be sharper than the corner portion 79 of the placement portion 74.

As described above, when the rolled medium R is removed from the winding unit 35, the rolled medium R is supported by the contact region C1 of the placement surface 57 of the placement portion 56 on the first support mechanism 51 side, the contact region C3 of the placement surfaces 59A and 59B of the second placement portions 58A and 58B on the first support mechanism 51 side, the contact region C1 of the placement surface 57 of the placement portion 56 on the second support mechanism 52 side, the contact region C3 of the placement surfaces 59A and 59B of the second placement portions 58A and 58B on the second support mechanism 52 side, and the like.

When the rolled medium R is supported by the placement portion 74 according to the comparative example, the corner portion 79 (a part of a contact region C1 of the placement surface 75) pointed toward the Z (+) direction first comes into contact with the rolled medium R. Thus, compared with a case where the entire contact region C1 of the placement surface 75 contacts the rolled medium R, the pressure acting on the rolled medium R becomes stronger, the corner portion 79 pointed toward the Z (+) direction digs into the rolled medium R side, and defects that are difficult to repair, such as folds and scratches, are more likely to occur in the rolled medium R.

On the other hand, when the rolled medium R is supported by the placement portion 56 according to the exemplary embodiment, the placement surface 57 of the placement portion 56 is a curved surface that is curved to be convex in the Z (+) direction and does not include a corner portion pointed in the Z (+) direction. In this case, the entire contact region C1 of the placement surface 57 is brought into contact with the rolled medium R, and, compared with a case where a part of the contact region C1 of the placement surface 57 contacts the rolled medium R, the pressure acting on the rolled medium R becomes weaker, and defects that are difficult to repair, such as folds and scratches, are less likely to occur in the rolled medium R.

When the rolled medium R is supported by the second placement portion 81 according to the comparative example, the corner portion 85 (a part of a contact region C3 of the placement surface 82) pointed toward the Z (+) direction first comes into contact with the rolled medium R. Thus, compared with a case where the entire contact region C3 of the placement surface 82 contacts the rolled medium R, the pressure acting on the rolled medium R becomes stronger, the corner portion 85 pointed toward the Z (+) direction digs into the rolled medium R side, and defects that are difficult to repair, such as folds and scratches, are more likely to occur in the rolled medium R.

On the other hand, when the rolled medium R is supported by the second placement portions 58A and 58B according to the exemplary embodiment, the placement surfaces 59A and 59B of the second placement portions 58A and 58B are curved surfaces that are curved to be convex in the Z (+) direction and do not include a corner portion pointed in the Z (+) direction. In this case, the entire contact region C3 of the placement surfaces 59A and 59B is brought into contact with the rolled medium R, and, compared with a case where a part of the contact region C3 of the placement surfaces 59A and 59B contacts the rolled medium R, the pressure acting on the rolled medium R becomes weaker, and defects that are difficult to repair, such as folds and scratches, are less likely to occur in the rolled medium R.

In this way, when the rolled medium R is removed from the winding unit 35, defects that are difficult to repair, such as folds and scratches, are less likely to occur in the rolled medium R in the configuration (the placement surfaces 57, 59A, and 59B of the placement portions 56, 58A, and 58B according to the exemplary embodiment) in which the placement surface on which the rolled medium R is temporarily placed is a curved surface that is curved to be convex in the Z (+) direction than in the configuration (the placement surfaces 75 and 82 of the placement portions 74 and 81 according to the comparative example) in which the placement surface is an inclined flat surface to be convex in the Z (+) direction.

Therefore, when viewed from the Y direction intersecting the X direction, the placement surface 57 of the placement portion 56 and the placement surfaces 59A and 59B of the second placement portions 58A and 58B on which the rolled medium R is placed are preferably curved to be convex in the Z (+) direction.

### MODIFICATION EXAMPLE

In the above-described exemplary embodiment, the support mechanism 50 includes the placement portion 56 that can support the rolled medium R and the position adjustment unit 55 that rises the placement portion 56 in the Z (+) direction when the rolled medium R is removed from the support portion 37. The position adjustment unit 55 includes the levers 41 and 42, the cam 66, and the shaft 69. Then, by converting rotational movement of the levers 41 and 42 into oscillatory movement in the Z (+) direction or the Z (−) direction of the cam 66, the operator manually rises and lowers the placement portion 56 in the Z (+) direction or the Z (−) direction.

For example, the position adjustment unit 55 may include a drive unit, and the drive unit may be configured to automatically rise and lower the placement portion 56 in the Z (+) direction or the Z (−) direction. Such a configuration further reduces a burden on the operator.

For example, instead of being rised and lowered by the oscillatory movement of the cam 66, the placement portion 56 may be configured to be rised and lowered by a ball screw, or the placement portion 56 may also be configured to be rised and lowered by a jack.

The contents derived from the above-described exemplary embodiment will be described below.

A recording device of the present application includes a winding unit configured to wind medium into a roll shape to form a rolled medium, wherein the winding unit includes a rail extending in a first direction, and a support mechanism supported on the rail and configured to move in the first direction, the support mechanism includes a placement portion configured to support the rolled medium from a vertically downward direction side, and a position adjustment unit configured to rise the placement portion in a vertically upward direction when the rolled medium is removed from a support portion, and when viewed from a second direction intersecting the first direction, a placement surface of the placement portion on which the rolled medium is placed is curved to be convex in the vertically upward direction.

The support mechanism includes the placement portion that can support the rolled medium from the vertically downward direction side and the position adjustment unit that rises the placement portion in the vertically upward direction when the rolled medium is removed from the winding unit. Then, the operator can remove the rolled medium from the winding unit by using the support mechanism, and thus a burden on the operator can be reduced and the operator can efficiently remove the rolled medium from the winding unit compared with a case where the rolled medium is removed from the winding unit manually without using the support mechanism.

Furthermore, when the placement surface on which the rolled medium is placed includes a pointed corner, the corner digs into the rolled medium, and defects (folds, scratches, and the like) that are difficult to repair are more likely to occur in the rolled medium. In the recording device of the present application, since the rolled medium is placed on the placement surface that is curved to be convex in the vertically upward direction, the rolled medium deforms along the curved placement surface. Accordingly, a specific portion of the placement surface is less likely to dig into the rolled medium, and defects that are difficult to repair are less likely to occur in the rolled medium.

Therefore, in the recording device of the present application, a burden on the operator when removing the rolled medium from the winding unit can be reduced, and the operator can efficiently remove the rolled medium from the winding unit while occurrence of defects that are difficult to repair can be suppressed in the rolled medium.

In the recording device of the present application, the support mechanism preferably further includes a second placement portion that is located at the first direction side of the placement portion and configured to support the rolled medium from the vertically downward direction side, and when viewed from the second direction, a placement surface of the second placement portion on which the rolled medium is placed is preferably curved to be convex in the vertically upward direction.

When the rolled medium is removed from the winding unit, the rolled medium is supported by the placement portion and the second placement portion, and thus an area of the region, in which the rolled medium is supported, of the placement portion and the second placement portion is greater than that in a case where the rolled medium is supported only by the placement portion. As a result, compared with a case where an area of the region in which the rolled medium is supported is small, the pressure acting on the rolled medium becomes weaker, excessive force is less likely to act on the rolled medium, and defects (folds, scratches, and the like) that are difficult to repair due to the excessive force are less likely to occur in the rolled medium.

In the recording device of the present application, the position adjustment unit preferably includes a shaft extending in the second direction, a lever that is fixed to the shaft and rotates with the shaft serving as a fulcrum, a cam that is fixed to the shaft, oscillates in the vertically upward direction or the vertically downward direction with the shaft serving as a fulcrum, and converts rotational movement of the lever into oscillatory movement in the vertically upward direction or the vertically downward direction, a rising and lowering portion that is rised and lowered in the vertically upward direction or the vertically downward direction by the cam, and supports the placement portion, and a base that houses the rising and lowering portion, and the lever preferably intersects the second direction.

When the lever located on the opposite side from the rising and lowering portion of the base intersects the second direction, a dimension in the second direction of the position adjustment unit can be shortened, and a dimension in the second direction of the support mechanism can be shortened, compared with a case where the lever does not intersect the second direction.

In the recording device of the present application, the support mechanism preferably includes a first support mechanism and a second support mechanism, the lever preferably includes a first lever provided in the first support mechanism and a second lever provided in the second support mechanism, and a position in the second direction of the first lever is preferably different from a position in the second direction of the second lever such that the first lever and the second lever preferably do not interfere with each other when the first lever and the second lever are rotated with the shaft serving as a fulcrum.

By setting a position in the second direction of the first lever to be different from a position in the second direction of the second lever, the first lever and the second lever are prevented from interfering with each other when the first lever and the second lever are rotated with the shaft serving as a fulcrum. Thus, the first lever can be arranged closer to the second lever than those when both of them interfere with each other. As a result, an interval between the first support mechanism and the second support mechanism can be shortened by arranging the first support mechanism closer to the second support mechanism.

In the recording device of the present application, the rising and lowering portion preferably includes a first rising and lowering portion arranged at an inside of the base and a second rising and lowering portion that is arranged at an inside of the first rising and lowering portion and supports the placement portion.

For example, in a configuration in which the placement portion is rised and lowered only by the second rising and lowering portion, a length in the vertical direction of the second rising and lowering portion needs at least a length H when the placement portion is rised and lowered by the length H.

In the recording device of the present application, the placement portion can be rised and lowered by the length H by a first step of rising and lowering the second rising and lowering portion by a length H/2 and a next step of rising and lowering the second rising and lowering portion and the first rising and lowering portion by the length H/2. In this case, a length in the vertical direction of the first rising and lowering portion and the second rising and lowering portion may be the length H/2, and a length in the vertical direction of the rising and lowering portion (the first rising and lowering portion and the second rising and lowering portion) can be shortened further than that in the configuration in which the placement portion is rised and lowered only by the second rising and lowering portion.

In the recording device of the present application, a rolling body is preferably provided between the base and the first rising and lowering portion and between the first rising and lowering portion and the second rising and lowering portion.

When the first rising and lowering portion is rised and lowered with respect to the base while the rolling body provided between the base and the first rising and lowering portion is rotated, the first rising and lowering portion can be rised and lowered smoothly. When the second rising and lowering portion is rised and lowered with respect to the first rising and lowering portion while the rolling body provided between the first rising and lowering portion and the second rising and lowering portion is rotated, the second rising and lowering portion can be rised and lowered smoothly.

In the recording device of the present application, a plurality of the cams are preferably provided along the second direction.

The cam converts rotational movement of the lever into oscillatory movement in the vertically upward direction or the vertically downward direction, and provides, to the placement portion, force that rises and lowers the placement portion in the vertically upward direction or the vertically downward direction.

When the plurality of cams are provided, the number of regions of the placement portion on which the force that rises and lowers the placement portion acts is increased, and a posture of the placement portion when the placement portion is rised and lowered is stable, and the placement portion is rised and lowered with stability, compared with a case where a single cam is provided.

The recording device of the present application further includes a protective cover that is located on an opposite side of the base from the rising and lowering portion and configured to protect the lever, wherein an inclined surface, that is inclined in the vertically downward direction with an inceasing distance from the base, is preferably provided on the vertically upward direction side of the protective cover.

When removing the rolled medium from the winding unit, the operator presses the rolled medium supported on the placement portion toward the protective cover, and moves the rolled medium toward the protective cover while rotating the rolled medium. When the rolled medium reaches a portion on the vertically upward direction side of the protective cover, the rolled medium rolls along the inclined surface provided on the vertically upward direction side of the protective cover by gravity acting in the vertically downward direction, and is automatically discharged to the outside of the protective cover (winding unit).

In other words, the operator can discharge the rolled medium to the outside of the winding unit by the operation of moving the rolled medium toward the protective cover while rotating the rolled medium. Thus, the operation of carrying the rolled medium is not needed, and a burden on the operator when removing the rolled medium from the winding unit can be reduced.

What is claimed is:

1. A recording device comprising:
a winding unit configured to wind a medium into a roll shape to form a rolled medium, wherein
the winding unit includes
a rail extending in a first direction and
a support mechanism supported on the rail and configured to move in the first direction,
the support mechanism includes
a placement portion configured to support the rolled medium from a vertically downward direction, and
a position adjustment unit configured to rise the placement portion in a vertically upward direction, and
when viewed from a second direction intersecting the first direction, a placement surface of the placement portion on which the rolled medium is placed is curved to be convex in the vertically upward direction.

2. The recording device according to claim 1, wherein
the support mechanism further includes a second placement portion aligned with the placement portion in the first direction and configured to support the rolled medium from the vertically downward direction, and
when viewed from the second direction, a placement surface of the second placement portion on which the rolled medium is placed is curved to be convex in the vertically upward direction.

3. The recording device according to claim 1, wherein
the position adjustment unit includes
a shaft extending in the second direction,
a lever fixed to the shaft and configured to rotate with the shaft serving as a fulcrum,
at least one cam fixed to the shaft, the at least one cam being configured to rotate to convert rotational movement of the lever into oscillatory movement in the vertically upward direction or the vertically downward direction,
a rising and lowering portion configured to rise in the vertically upward direction or configured to lower in the vertically downward direction by the at least one cam and that supports the placement portion, and
a base housing the rising and lowering portion, and
the lever intersects the second direction.

4. The recording device according to claim 3, further comprising:
a second support mechanism; and
a second lever disposed in the second support mechanism, wherein
a position of the lever in the second direction is different from a position of the second lever in the second direction such that the lever and the second lever do not interfere with each other when the lever and the second lever are rotated with the shaft serving as a fulcrum.

5. The recording device according to claim 3, wherein the rising and lowering portion includes a first rising and lowering portion disposed inside the base and
a second rising and lowering portion disposed inside the first rising and lowering portion and that supports the placement portion.

6. The recording device according to claim 5, wherein at least one rolling body is disposed between the base and the first rising and lowering portion and between the first rising and lowering portion and the second rising and lowering portion.

7. The recording device according to claim 3, wherein plural cams are disposed along the second direction.

8. The recording device according to claim 3, further comprising:
a protective cover located opposite to the base from the rising and lowering portion and that is configured to protect the lever, wherein
an inclined surface, that is inclined in the vertically downward direction as leaving from the base, is disposed at the vertically upward direction of the protective cover.
